(19) United States
(12) Patent Application Publication
(10) Pub. No.: US 2003/0097774 A1
(43) Pub. Date: May 29, 2003

(54) Methods and assemblies for changing vending machine sign face graphics

(76) Inventors: Arthur G. Rudick, Atlanta, GA (US); William S. Credle JR., Roswell, GA (US)

Correspondence Address: Finnegan, Henderson, Farabow,, Garrett & Dunner, L.L.P., 1300 I Street, N.W., Washington, DC, 20005-3315, US

(21) Appl. No.: 10/228,055

(22) Filed: Aug. 27, 2002

Related U.S. Application Data
(63) Continuation-in-part of application No. 09/771,973, filed on Jan. 30, 2001, now Pat. No. 6,499,242.
Application No. 09/771,973 is a division of application No. 09/219,358, filed on Dec. 23, 1998, now Pat. No. 6,195,924.

(51) Int. Cl. G09F 11/18

(52) U.S. Cl. 40/514

(57) ABSTRACT

In combination with a merchandise display cabinet having a front face with a display field therein, an apparatus for selectively placing a graphics region in the display field may include a graphics sheet having a leading edge and a trailing edge and a plurality of graphics regions between the leading edge and the trailing edge. The apparatus also includes a spool assembly including a first spool disposed on one side of the display field and a second spool disposed on an opposite side of the display field. The graphics sheet may be windable on the first spool and the second spool to extend across the display field. The apparatus also includes a drive mechanism configured to rotate at least one of the first spool and the second spool to selectively position a selected one of the plurality of graphics regions into registry with the display field and a controller configured to selectively activate the drive mechanism to position the selected one of the plurality of graphics regions in the display field.

This application is a continuation-in-part of U.S. patent application Ser. No. 09/711,973, pending, which is a divisional of U.S. patent application Ser. No. 09/219,358, now U.S. Pat. No. 6,195,924.

### BACKGROUND OF THE INVENTION

The present invention relates to a method and apparatus for displaying interchangeable graphic sheets on the display face of a merchandise cabinet, such as a coin-operated vending machine. More specifically, the present invention relates to improved methods and systems for storing interchangeable graphic sheets within the vending machine cabinet, and methods and assemblies for quickly and efficiently changing the graphic sheets in order to achieve high quality graphic displays.

Traditionally, graphic sheets on the front doors of vending machines were more or less permanently installed. If it was desired to change the graphics on these doors, it often took between fifteen minutes to two hours to change the signs in order to display new graphics.

Recently there has been a trend in the vending machine industry to provide interchangeable graphic sheets on portions of the vending machine sign panel, such as in a window provided in the panel surrounded by more permanent associated graphics. Various means for quickly changing such graphic sheets have been contemplated. An example of one such system is described in U.S. Pat. No. 5,509,225 to Minh et al., assigned to the same assignee as the present invention.

In Minh, the interchangeable graphic sheets may be rolled up and stored in the machine in any suitable space therein. However, no specific storage device is provided for the rolled sheets, so the sheets may become crumpled or damaged making it difficult to neatly and efficiently change the graphic sheets on the windows of the associated sign panels.

Therefore, there is a need in the art for methods and systems for neatly and efficiently storing rolled-up graphic sheets in or near vending machines which lend themselves to quick interchangeability of the sheets either manually or automatically.

### SUMMARY OF THE INVENTION

The present disclosure is directed to a method of displaying interchangeable graphic sheets on a display face of a merchandise cabinet comprising the steps of: providing a storage spool assembly in or near the cabinet with interchangeable graphic sheets thereon; unwinding a selected one of the graphic sheets from the spool assembly; placing the selected graphic sheet in a display field on the display face for a desired period of time; removing the selected graphic sheets from a display field at the end of the desired period of time; unwinding a different graphic sheet from the spool assembly; placing the different graphic sheet in the display field; and repeating the above steps as often as desired to effect a display of interchangeable graphics.

According to one aspect of the disclosure, each graphic sheet is wound on a separate spool and has adhesive material on either of the leading or trailing end of the sheet. In order to effect the interchange of the sheets an end of the old graphic sheet just removed from the display field is secured to the leading end of a new graphic sheet on another spool to form a leader for the new graphic sheet by pressing the leading and trailing ends together to form an adhesive coupling. The new graphic sheet is then unwound by manually pulling on the old graphic sheet. The old graphic sheet is then detached from the new graphic sheet and the old graphic sheet is wound onto a spool for future use.

According to another aspect of the disclosure, each graphic sheet wound on the spool has a flexible elongated leader on a leading edge thereof for unwinding the graphic sheet from the spool. The leader is readily severable from the graphic sheet so that it can be removed once the sheet is secured in the display field of the sign face.

According to yet another aspect of the disclosure, a continuous graphic sheet is provided with separate graphics regions thereon. The sheet is wound on a spool and selected regions of the graphic sheet are unwound from the spool into registry with the display field on the sign panel for selected display periods.

According to still another aspect of the disclosure, the spool assembly includes two spaced spools disposed at opposite ends of the display field, and the selective placing of graphics regions is implemented by winding the graphic sheet from one spool to the other. A drive mechanism is provided for rotating the first and second spools to selectively position the selected ones of the groups of graphics into registry with a display field. A controller is provided for selectively activating the drive mechanism. In one aspect, the controller includes a timer for automatically activating the drive mechanism to change the groups of graphics displayed at selectable intervals. In another aspect, the controller includes a detector responsive to remote command signals for activating the drive mechanism.

Further scope of applicability of the present invention will become apparent from the detailed description given hereinafter. However, it should be understood that the detailed description and specific examples are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a vending machine illustrating a sign panel on the front face thereof defining a display field in which the interchangeable graphic sheets may be substituted as desired to achieve different displays;

FIG. 2 is a section al view along line 2-2 of FIG. 1 illustrating the spaced inner and outer sign faces between which the graphic sheets are interchangeably mountable;

FIG. 3 is a first example of an interchangeable graphic sheet for use in a first method of the present invention;

FIG. 4 illustrates a graphic sheet for a second aspect of the present invention provided with an integrally attached leader;

FIG. 5 is a front elevational view of a storage spool assembly for storing the graphic sheet of FIG. 4 thereon;

FIG. 6 is a cross-sectional view taken along line 2-2 of FIG. 1 illustrating the location of the spool assembly of FIG. 5 and the position of the leader and graphics sheet of the second aspect of FIG. 4 between the front and rear sign faces; and

FIG. 7 is a diagrammatic view of a third aspect of the present invention including an automatically changeable graphic sheet assembly.

### DETAILED DESCRIPTION OF THE INVENTION

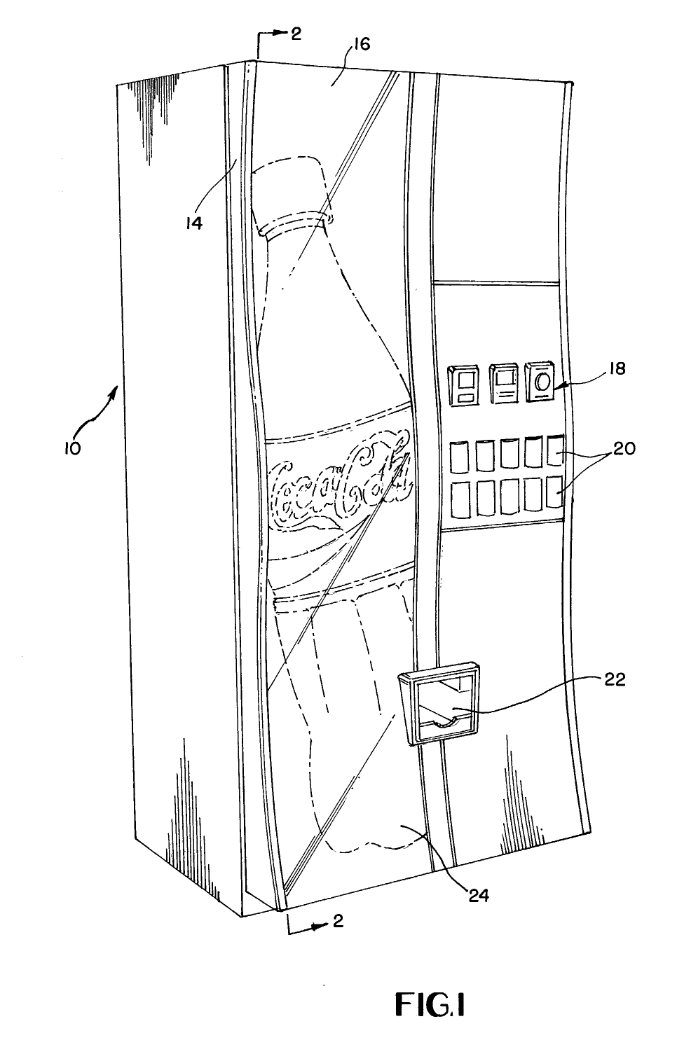

Referring to FIG. 1, there is illustrated a vending machine generally indicated 10 having a hinged front door 14 with a sign panel 16 thereon in which interchangeable graphic displays or sheets are mounted in accordance with the methods and assemblies of the present invention. One such graphic sheet 24 is depicted which is the proprietary bottle of The Coca-Cola Company, and a registered trademark. The vending machine 10 also includes a coin-operated mechanism 18, a plurality of selection buttons 20 and a discharge port 22 for the vendable products. The vending machine 10 illustrated in FIG. 1 is merely one example of a type of vending machine suitable for use with the methods and assemblies of the present invention.

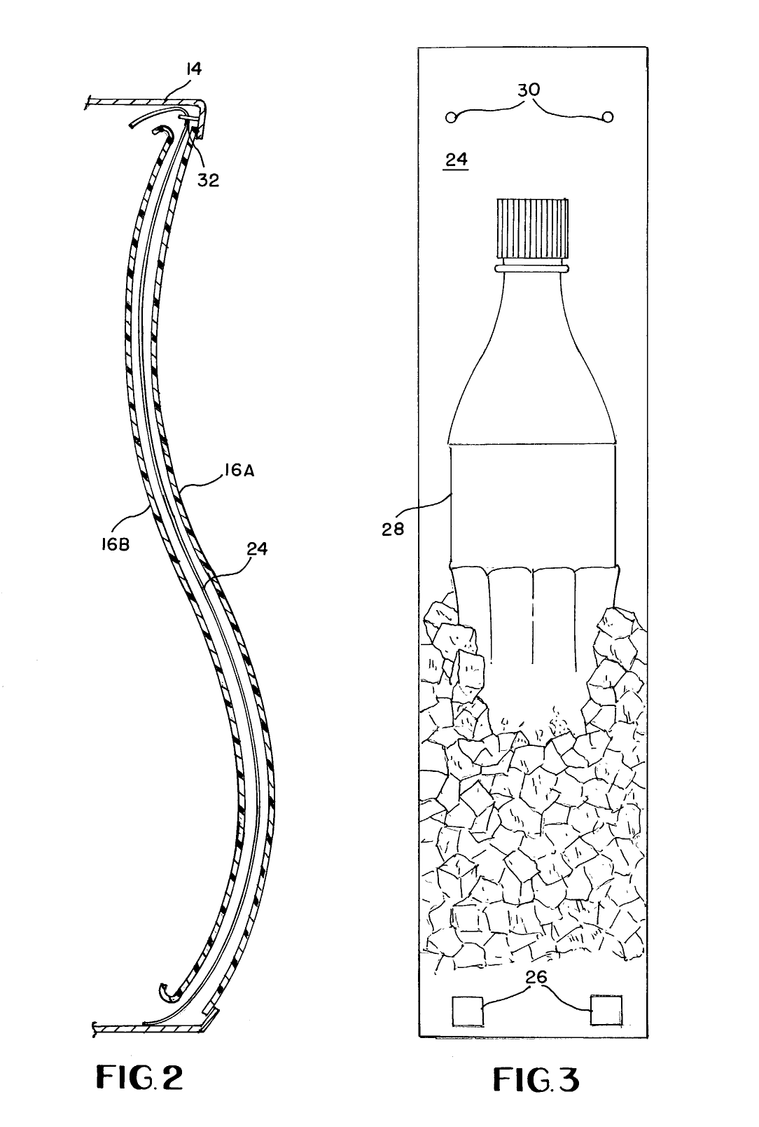

Referring to FIGS. 2 and 3, there is illustrated a first aspect of the present invention which illustrates two parallel sign faces 16A and 16B of the door 14 which are separated by a gap of approximately ⅛-inch. The outer sign face 16A should be thick enough to provide vandal resistance and is attached to the door frame of door 14. The inner sign face 16B is attached to the outer sign face via ⅛-inch thick spacer strips located between both vertical edges of the sign faces. These spacer strips are omitted from the drawing for clarity. The graphic sheet 24 is located in the space between the two sign faces 16A, 16B. The ⅛-inch thick spacer strips define the vertical edges of the space and the display field for the graphic sheets and thus locate the graphics sheet horizontally.

Registration holes 30 are provided in the top of the graphics sheet to hook the sheet over registration pegs 32 on the door frame. The upper attachment area including the registration pegs 32 is disposed slightly above the two sign face regions within the door 14. A lower attachment area extends slightly below the bottom of the two sign faces 16A, 16B. The graphic sheet 24 is formed from a flexible transparent material such as Mylar and has the graphics 28 printed thereon. Additional graphics sheets 24 are storable on spools such as cardboard cores (not shown) and which are preferably stored somewhere within a suitable space in the vending machine. The bottom of a graphics sheet 24 may be provided with adhesive material which is preferably two pieces of doubled-faced tape 26.

In order to change the graphics sheet 24, a service technician may open the vending machine's door 14 to access the interior of the graphics area, unwind the new graphics sheet 24 from its storage core, and remove the cover papers from the pieces of double-face tape 26 on the lower attachment area. The technician may then fasten the lower attachment area of the new graphics sheet 24 to the upper attachment area of the old graphics sheet via the double-faced tape 26, unhook the old graphics sheet from the registration pegs 32, and pull on the lower attachment area of the old graphics sheet using the old graphics sheet as a leader to pull the new graphics sheet into the space between the sign faces 16A, 16B.

When the new graphic sheet is in place, its registration holes 30 may be hooked over the registration pegs 32. The old graphics sheet may be detached and wound around the storage core for re-use at a later date. Accordingly, a neat and efficient method and assembly are provided for storing and interchangeably displaying flexible graphic sheets on the sign face of a vending machine.

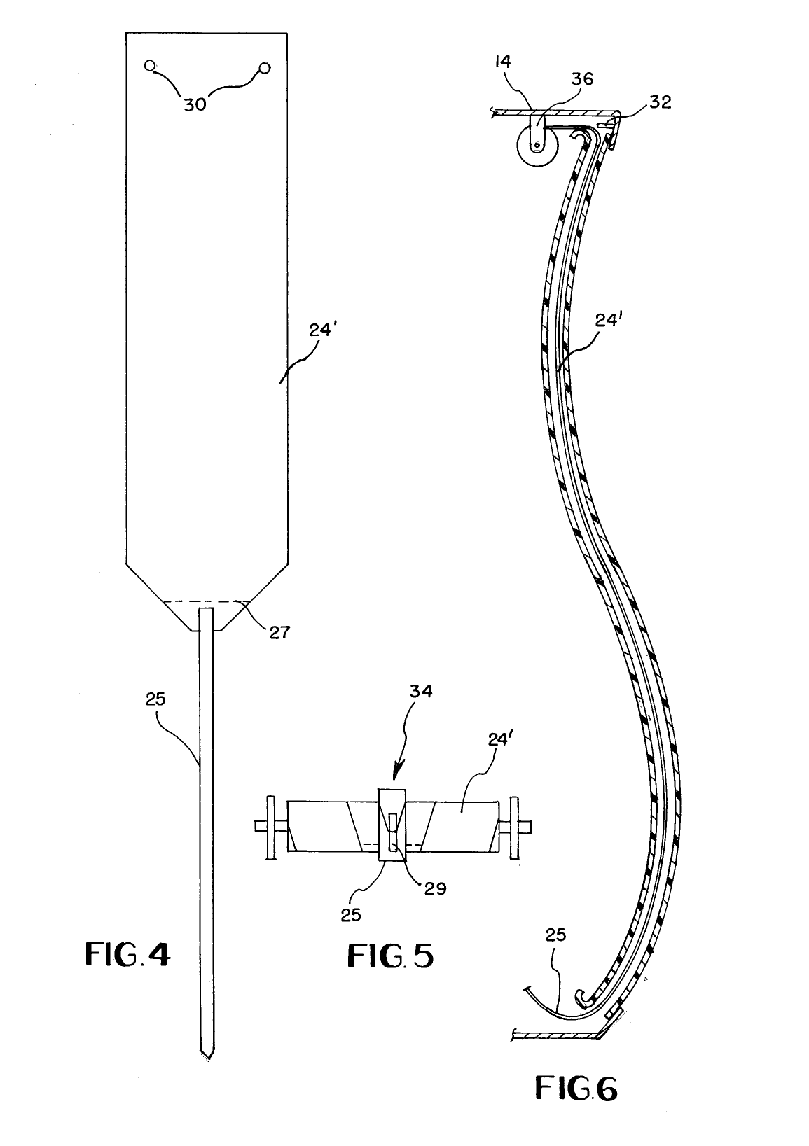

The second aspect of the present invention is illustrated in FIGS. 4-6. Referring to FIG. 4, the graphics sheet 24′ comes with a semi-ridged leader strip 25 attached to the bottom end thereof. The leader strip 25 is flexible enough so that it can be wound around a flanged spool 34 illustrated in detail in FIG. 5. The leader 25 is ridged enough to allow it to be fed all of the way through the space between the sign faces 16A, 16B by pushing it from the top as illustrated in FIG. 6.

The graphics sheet 24′ and leader 25 are wound around the storage spool 34 as illustrated in FIG. 5. The flanged storage spool 34 is mounted in the top of the door 14 in spaced brackets 36. The storage spool 34 easily snaps into the brackets 36 using the same method that you would use to snap a roll of paper towers into a kitchen paper towel holder. The storage spool 34 guides the graphic sheets straight into the space between the sign faces 16A and 16B, thus preventing wrinkling or binding. The leader 25 is windable on the spool along with the graphics sheet 24′ and may be secured at it's end by a piece of removable tape 29.

In order to change the graphics sheet 24′, a service technician may open the vending machine door 14 to access the interior of the graphics area, remove the old graphics sheet, and snap the new graphics sheet storage spool assembly 34 into the “paper towel holder” type brackets 36. The technician may then untape the leader by removing tape 29 and feed the leader 25 into the top of the space between the sign faces 16A, 16B until it emerges out the bottom of the space. The tip of the leader 25 may then be grasped and used to pull the graphics sheet into registry with the display field between the respective sign face panels 16A, 16B. The registration holes 30 of the graphics sheet 24′ may be hooked over the registration pegs 32 and the storage spool, removed. The leader strip 25 may be removed by tearing the bottom tip of the graphics sheet 24′ off at the perforations 27.

The first and second aspects of the present invention describe manual methods for handling and interchanging the graphics sheets on the sign panel of a vending machine.

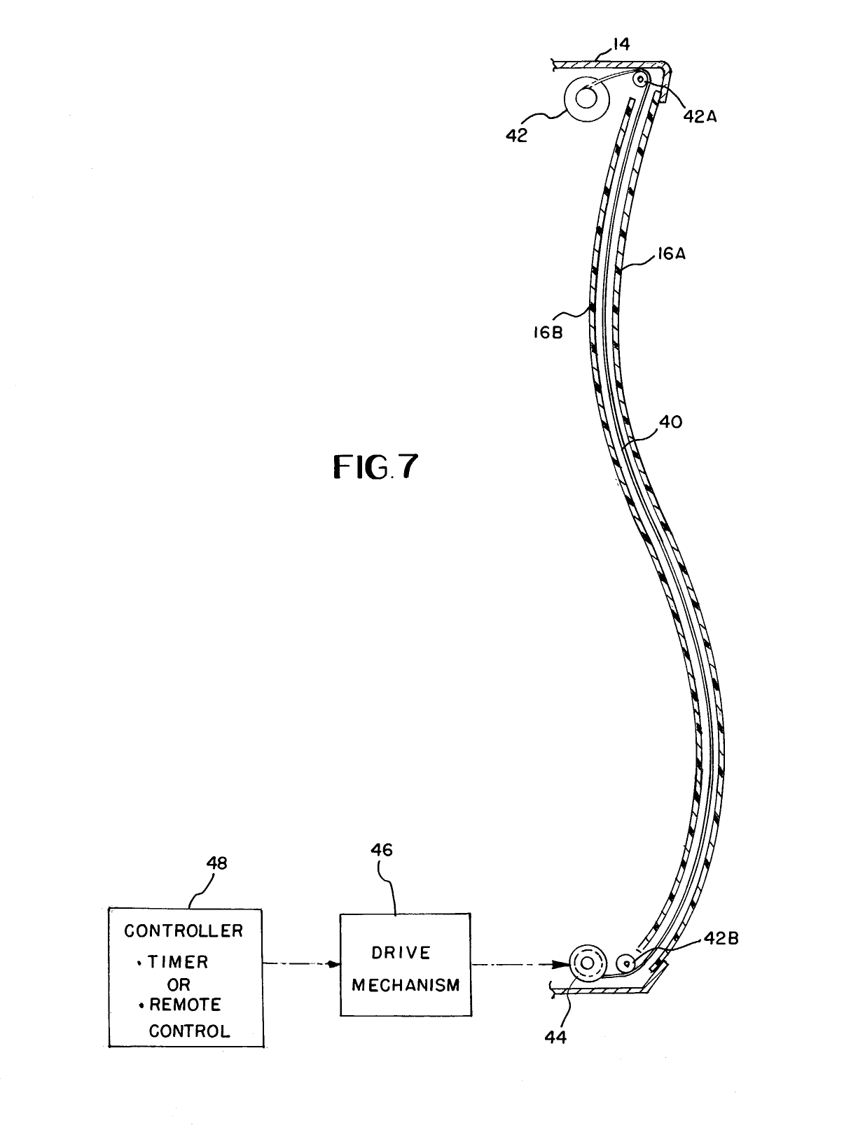

In a third aspect of the present invention, a method and assembly for automatically changing the sign face graphics is described and illustrated in FIG. 7.

As with the other aspects, the cross-sectional view of the sign panel including spaced faces 16A and 16B is illustrated as being disposed within the vending machine door 14. The interchangeable graphics sheet is illustrated at 40 and comprises a continuous thin flexible sheet with spaced separate sign face graphic regions printed end to end along the sheet. The sheet 40 is wound on a first spool 42 and a second spool 44 disposed at the top and bottom of the sign face defining a display field therebetween. The sheet 40 feeds over idler rollers 42A and 42B as it moves from one spool to the other. A suitable drive mechanism 46 is provided to drive one or both spools 42, 44, as desired.

A controller 48 is provided to activate the drive mechanism 46. The controller 48 may include a timer or a remote control device for operating the drive mechanism in a manner to be more fully described hereinafter. The long sheet 40 including the plurality of spaced graphics regions is rotated to selectively position the regions into registry in a display field between their respective spools 42 and 44 by operation of the drive mechanism 46.

The timer within controller 48 may be designed to initiate command signals to the drive mechanism to selectively position the graphics display regions into the display field for desired periods of time. These periods of time may be predetermined or programmable as desired. The position of the graphics on the sheet 40 with respect to the display field can be registered by any one of several methods. Possible registration methods include the use of dots of magnetic ink near the sheet's edge picked up by an associated magnetic sensor within the vending machine cabinet, or by the use of holes near the sheet's edge, which would be detected by appropriate optical sensors.

A person skilled in the art would recognized that the aforementioned aspects of the disclosure may be combined with one another. For example, the graphics sheet 40 may be positioned in the display field by attaching the graphics sheet 40 to a first graphics sheet that is already positioned in the display field. The graphics sheets may be attached together by, for example, an adhesive, a hook-and-loop fastener, or the like. The first graphics sheet may be removed from the display field, thereby positioning the graphics sheet 40 in the display field.

The first graphics sheet may be detached from the graphics sheet 40. If detached, the graphics sheet 40 may be wrapped on the second spool 44, and the first graphics sheet may be wrapped on a separate spool and stored for future use. Alternatively, the first graphics sheet may be wrapped onto the second spool 44 while remaining attached to the graphics sheet 40.

If the graphics sheet 40 is removed from a storage spool before or after being positioned in the display field, the first graphics sheet, if detached, may be wrapped on that spool. In this situation, the graphics sheet 40 may then be wrapped on the first spool 42. Alternatively, the graphics sheet 40 may remain on the storage spool, and the storage spool may be mounted to the merchandise cabinet as the first spool 42. In any event, the spool with the first graphics sheet, if detached from the graphics sheet 40, may be stored proximate to or remote from the merchandise cabinet.

Alternatively, the graphics sheet 40 may have an elongated leader configured to be fed through the slot between the sign faces 16A, 16B. The elongated leader may be inserted into a first end of the slot and fed through the slot and out of a second opposite end of the slot. The leader may be pulled through the slot until the graphics sheet 40 is positioned in the display field as desired. The leader may be removed from the graphics sheet 40, and the graphics sheet 40 may be wound on the second spool 44. Alternatively, the leader may be wound onto the second spool 44 while remaining attached to the graphics sheet 40.

The graphics sheet 40 may be removed from a storage spool and wrapped on the first spool 42, or alternatively, the graphics sheet 40 may remain on the storage spool, and the storage spool may be mounted to the merchandise cabinet as the first spool 42.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. In combination with a merchandise display cabinet having a front face with a display field therein, an apparatus for selectively placing a graphics region in the display field, the apparatus comprising:
a graphics sheet having a leading edge and a trailing edge and a plurality of graphics regions between the leading edge and the trailing edge;
a spool assembly including a first spool disposed on one side of the display field and a second spool disposed on an opposite side of the display field, the graphics sheet being windable on the first spool and the second spool to extend across the display field;
a drive mechanism configured to rotate at least one of the first spool and the second spool to selectively position a selected one of the plurality of graphics regions into registry with the display field; and
a controller configured to selectively activate the drive mechanism to position the selected one of the plurality of graphics regions in the display field.

2. The apparatus of claim 1, wherein the controller includes a timer associated with the controller, the timer being configured to actuate the drive mechanism at selectable intervals.

3. The apparatus of claim 2, further comprising a detector associated with the controller, the detector being configured to respond to command signals to actuate the drive mechanism.

4. The apparatus of claim 3, wherein the command signals originate from a location remote from the merchandise display cabinet.

5. The apparatus of claim 1, further comprising a storage spool having a second graphics sheet thereon.

6. The apparatus of claim 5, further comprising a fastener configured to attach the second graphics sheet to one of the leading edge and the trailing edge of the graphics sheet when the graphics sheet is unwound from at least one of the first spool and the second spool,
wherein, when the second graphics sheet is attached to the graphics sheet, removal of the graphics sheet from the display field places the additional graphics sheet in the display field.

7. The apparatus of claim 6, wherein the fastener is uncoupleable, and wherein the second graphics sheet is windable on said at least one of the first spool and the second spool.

8. The apparatus of claim 7, wherein the storage spool is mountable to the merchandise cabinet to replace one of the first spool and the second spool.

9. The apparatus of claim 1, further comprising an elongated leader associated with the graphics sheet.

10. The apparatus of claim 8, further comprising spaced apart panels defining a slot associated with the display field.

11. The apparatus of claim 9, wherein the elongated leader is configured to be fed through the slot associated with the display field.

12. A method of displaying graphics in a display field of a merchandise cabinet, the method comprising:
providing a graphics sheet having a leading edge and a trailing edge and a plurality of separate graphics regions between the leading edge and the trailing edge;
winding the graphics sheet on a first spool disposed on one side of the display field and on a second spool disposed on an opposite side of the display field such that the graphics sheet extends across the display field; and
controllably rotating at least one of the first spool and the second spool to selectively position a selected one of the plurality of graphics regions into registry with the display field.

13. The method of claim 12, further comprising feeding an elongated leader associated with the graphics sheet into a first end of a slot, the slot being formed by two spaced panels associated with the display field of the merchandise cabinet.

14. The method of claim 13, further comprising:
feeding the elongated leader through the slot and out of a second opposite end of the slot;
pulling a portion of the elongated leader emerging from the second end of the slot until the graphics sheet occupies the display field; and
winding the elongated leader on one of the first spool and the second spool.

15. The method of claim 13, further comprising:
feeding the elongated leader through the slot and out of a second opposite end of the slot;
pulling a portion of the elongated leader emerging from the second end of the slot until the elongated leader is removed from the display field;
detaching the elongated leader from the graphics sheet; and
winding the graphics sheet on one of the first spool and the second spool.

16. The method of claim 12, further comprising:
unwinding at least one of the leading edge and the trailing edge of the graphics sheet from a respective one of the first spool and the second spool;
attaching a first end of a second graphics sheet to one of said at least one of the leading edge and the trailing edge of the graphics sheet; and
positioning the second graphics sheet in the display field by removing the graphics sheet from the display field.

17. The method of claim 16, further comprising:
replacing one of the first spool and the second spool with a third spool associated with the second graphics sheet; and
winding the first end of the second graphics sheet on one of the first spool and the second spool.

18. The method of claim 17, wherein said winding the first end includes winding the graphics sheet on said one of the first spool and the second spool.

19. The method of claim 16, further comprising:
removing the second graphics sheet from a third spool and winding the second graphics sheet on the first spool and the second spool;
detaching the graphics sheet from the second graphics sheet; and
winding the graphics sheet on the third spool.

20. The method of claim 12, wherein said controllably rotating furthering comprising selectively placing selected ones of the plurality of graphics regions in the display field in seriatim for selected display periods.
